(19) United States
(12) Patent Application Publication
(10) Pub. No.: US 2021/0162674 A1
(43) Pub. Date: Jun. 3, 2021

(54) APPARATUS FOR SUPPLYING PELLET AND METHOD FOR SUPPLYING PELLET

(71) Applicant: Electronics and Telecommunications Research Institute, Daejeon (KR)

(72) Inventors: Kyung Hyun KIM, Daejeon (KR); Hyun-cheol BAE, Sejong-si (KR)

(73) Assignee: Electronics and Telecommunications Research Institute, Daejeon (KR)

(21) Appl. No.: 17/109,871

(22) Filed: Dec. 2, 2020

(30) Foreign Application Priority Data
Dec. 3, 2019 (KR) 10-2019-0159124
Apr. 7, 2020 (KR) 10-2020-0042192

(51) Int. Cl. B29C 64/321; B33Y 30/00; B33Y 10/00

(52) U.S. Cl. CPC B29C 64/321; B29C 64/106; B33Y 10/00; B33Y 30/00

(57) ABSTRACT

Provided is an apparatus for supplying a pellet, the apparatus including a supply chamber accommodating a pellet, a rotation unit connected to a driving unit, and a supply unit coupled to the supply chamber. Here, the rotation unit includes a rotation shaft extending in a first direction, a screw coupled to an outer surface of the rotation shaft and progressing in the first direction, and a scraper extending from the outer surface of the rotation shaft in a direction crossing the first direction. Also, the supply unit surrounds the screw, and the scraper is disposed in the supply chamber while being positioned higher than the screw.

### CROSS-REFERENCE TO RELATED APPLICATIONS

This U.S. non-provisional patent application claims priority under 35 U.S.C. § 119 of Korean Patent Application Nos. 10-2019-0159124, filed on Dec. 3, 2019, and 10-2020-0042192, filed on Apr. 7, 2020, the entire contents of which are hereby incorporated by reference.

### BACKGROUND

The present disclosure herein relates to an apparatus for supplying a pellet and a method for supplying a pellet, and more particularly, to an apparatus for supplying a pellet, which is capable of uniformly extruding a pellet, and a method for supplying a pellet

Three-dimensional (3-D) printing is a method of processing a 3-dimensional shape by laminating materials, and there are various methods for the 3-D printing. For example, fused deposition modeling (FDM) refers to a method of processing a 3-dimensional shape by melting a filament-shaped material and laminating a 2-dimensional cross-sectional shape. Before performing the FDM, a thermoplastic polymer is melted at a high temperature, and then a wire-shaped filament is manufactured by using an extruder in advance. In order to process the polymer material into the filament shape, viscosity, extruding speed, and cooling speed have to be property adjusted. A material such as an inorganic material may be additionally mixed to improve strength and thermal stability of the material. As another method for the 3-D printing, the thermoplastic polymer may be processed into a pellet shape. When the material having the pellet shape is used, a large amount of small pellets may be inserted to a small-sized precision extruder for the 3-D printing by using a chamber.

### SUMMARY

The present disclosure provides an apparatus for supplying a pellet, which is capable of uniformly extruding a pellet, and a method for supplying a pellet.

The present disclosure also provides an apparatus for supplying a pellet, which is capable of preventing a bottleneck phenomenon of a pellet at an inlet of a supply unit, and a method for supplying a pellet.

The present disclosure also provides an apparatus for supplying a pellet, which is capable of removing a pore in the supply unit, and a method for supplying a pellet.

The present disclosure also provides an apparatus for supplying a pellet, which is capable of preventing a pellet from being melted in advance, and a method for supplying a pellet.

The present disclosure also provides an apparatus for supplying a pellet, which is capable of preventing a pellet from being clogged by melting of the pellet, and a method for supplying a pellet.

The present disclosure also provides an apparatus for supplying a pellet, which is capable of using various materials in 3-D printing, and a method for supplying a pellet.

The present disclosure also provides an apparatus for supplying a pellet, which is capable of simplifying a process, and a method for supplying a pellet.

The object of the present invention is not limited to the aforesaid, but other objects not described herein will be clearly understood by those skilled in the art from descriptions below.

An embodiment of the inventive concept provides an apparatus for supplying a pellet, including: a supply chamber configured to accommodate a pellet; a rotation unit connected to a driving unit; and a supply unit coupled to the supply chamber. Here, the rotation unit includes: a rotation shaft extending in a first direction; a screw coupled to an outer surface of the rotation shaft and configured to progress in the first direction; and a scraper extending from the outer surface of the rotation shaft in a direction crossing the first direction. Also, the supply unit surrounds the screw, and the scraper is disposed in the supply chamber while being positioned higher than the screw.

In an embodiment, the scraper may have an extension direction perpendicular to the first direction.

In an embodiment, the scraper may have a bar shape.

In an embodiment, the scraper may be spaced upward by about 0.5 mm to about 2 mm from an upper boundary of the supply unit.

In an embodiment, the scraper may have a length in the extension direction, which is greater than a length of the screw in the extension direction of the scraper.

In an embodiment, the supply chamber may provide a pellet accommodation space having a diameter that gradually decreases in the first direction, the pellet accommodation space may be connected with an inner space of the supply unit, and a supply chamber body configured to define the pellet accommodation space may provide a coolant accommodation space therein.

In an embodiment, the apparatus may further include a heating unit coupled to an outer surface of the supply unit, and the heating unit may heat the pellet supplied to the inner space of the supply unit.

In an embodiment of the inventive concept, an apparatus for supplying a pellet includes: a supply chamber configured to accommodate a pellet; a rotation unit connected to a driving unit; and a supply unit coupled to the supply chamber. Here, the rotation unit includes: a rotation shaft extending in a first direction; and a screw coupled to an outer surface of the rotation shaft and configured to progress in the first direction. Also, the supply unit surrounds the screw, the supply chamber includes a supply chamber body and a pellet accommodation space defined by the supply chamber body, the pellet accommodation space has a diameter that gradually decreases in the first direction and is connected with an inner space of the supply unit, and the supply chamber body provides a coolant accommodation space therein.

In an embodiment, the coolant accommodation space may surround a portion of the supply unit and the pellet accommodation space.

In an embodiment, the apparatus may further include a coolant inlet and a coolant outlet, which are coupled to an outer surface of the supply chamber, and each of the coolant inlet and the coolant outlet may be connected to the coolant accommodation space.

In an embodiment, the coolant outlet may be positioned higher than the coolant inlet.

In an embodiment, the apparatus may further include a coolant pump connected to the coolant outlet or the coolant inlet.

In an embodiment of the inventive concept, a method for supplying a pellet includes: supplying a pellet to a supply chamber; pushing the pellet from the supply chamber to a supply unit by a scraper; and pushing the pellet downward while a screw disposed in the supply unit rotates forward. Here, the scraper is disposed in the supply chamber while being coupled to an upper side of a rotation shaft coupled with the screw.

In an embodiment, the method may further include pushing the pellet upward while the screw rotates reversely after the screw rotates forward to push the pellet downward.

In an embodiment, a ratio of the forward rotation and the reverse rotation may be about 5:1 to about 15:1.

In an embodiment, the method may further include supplying a coolant to a coolant accommodation space in the supply chamber.

Particularities of other embodiments are included in the detailed description and drawings.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a cross-sectional view illustrating an apparatus for supplying a pellet according to an embodiment of the inventive concept;

FIG. 2 is an enlarged cross-sectional view illustrating portion X of FIG. 1;

FIG. 3 is a flowchart representing a method for supplying a pellet according to an embodiment of the inventive concept; and

FIGS. 4 to 8 are cross-sectional views sequentially illustrating the method for supplying the pellet in FIG. 3.

### DETAILED DESCRIPTION

Exemplary embodiments of the present invention will be described with reference to the accompanying drawings so as to sufficiently understand constitutions and effects of the present invention. The technical ideas of the inventive concept may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims.

Like reference numerals refer to like elements throughout. The embodiment in the detailed description will be described with cross-sectional views and/or plan views as ideal exemplary views of the inventive concept. Also, in the figures, the dimensions of layers and regions are exaggerated for clarity of illustration. Areas exemplified in the drawings have general properties, and are used to illustrate a specific shape of a semiconductor package region. Thus, this should not be construed as limited to the scope of the present invention.

Also, although various terms are used to describe various components in various embodiments of the inventive concept, the component are not limited to these terms. These terms are only used to distinguish one component from another component. Embodiments described and exemplified herein include complementary embodiments thereof.

In the specification, the technical terms are used only for explaining a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Hereinafter, the present invention will be described in detail by explaining preferred embodiments of the invention with reference to the attached drawings.

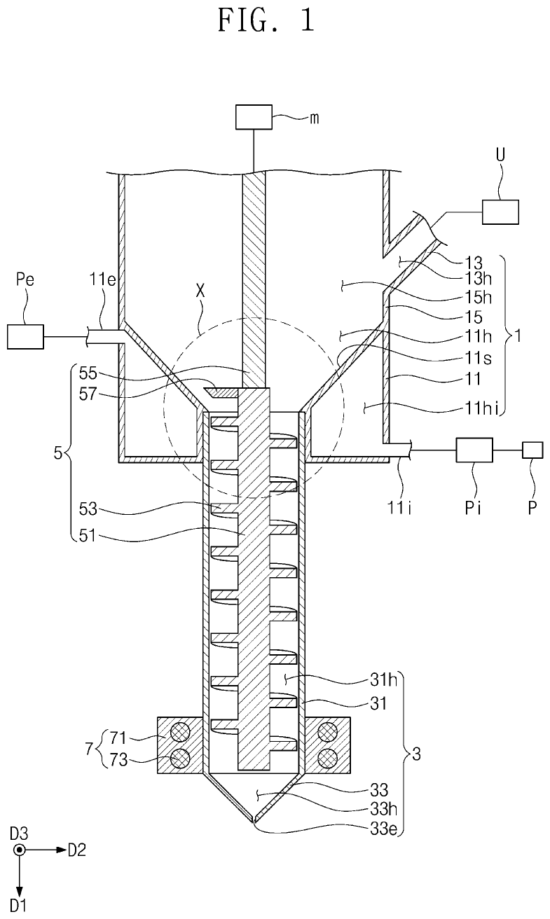

FIG. 1 is a cross-sectional view illustrating an apparatus for supplying a pellet according to an embodiment of the inventive concept.

Hereinafter, in FIG. 1, D1 may be referred to as a first direction, D2 may be referred to as a second direction, and D3 that is substantially perpendicular to the first direction D1 and the second direction D2 may be referred to as a third direction.

Referring to FIG. 1, an apparatus for supplying a pellet (hereinafter, referred to as a pellet supply apparatus) may be provided. The pellet supply apparatus may be used in three-dimensional (3-D) printing. That is, the pellet supply apparatus may be a portion of a 3-D printer. The pellet supply apparatus may serve to extrude a printing material in a 3-D printing process. The pellet supply apparatus may include a supply chamber 1, a supply unit 3, a rotation unit 5, a heating unit 7, a driving unit m, a pellet supplier U, and a coolant pump P.

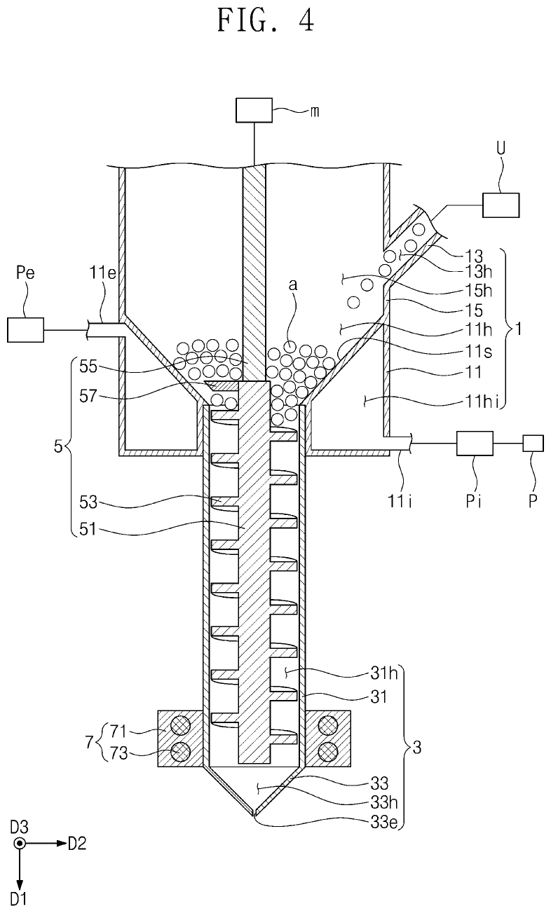

The supply chamber 1 may accommodate a pellet a (refer to FIG. 4). The supply chamber 1 may supply the pellet a to the supply unit 3. The supply chamber 1 may be connected to the pellet supplier U. The supply chamber 1 may receive the pellet from the pellet supplier U. The supply chamber 1 may receive the pellet from the pellet supplier U and supply the received pellet to the supply unit 3. The chamber 1 may include a supply chamber body 11, an extended body 15, an insertion part 13, a coolant inlet 11i, and a coolant outlet 11e.

The supply chamber body 11 may define a pellet accommodation space 11h.

That is, the supply chamber body 11 may surround the pellet accommodation space 11h. In embodiments, the supply chamber body 11 may have an appearance of a cylindrical shape. However, the embodiment of the inventive concept is not limited thereto. The pellet a may be accommodated in the pellet accommodation space 11h. The pellet accommodation space 11h may have a diameter that gradually decreases in the first direction D1. That is, an inner surface 11s of the pellet accommodation space 11h may have a diameter that decreases in a downward direction. The pellet accommodation space 11h may be connected to an inner space 31h of the supply unit 3. The pellet a accommodated in the pellet accommodation space 11h may be supplied to an inner space 31h of the supply unit 3. The supply chamber body 11 may provide a coolant accommodation space 11hi. More specifically, the coolant accommodation space 11hi may be provided in the supply chamber body 11. The coolant accommodation space 11hi may not be connected to the pellet accommodation space 11h.

That is, the coolant accommodation space 11hi may be separated from the pellet accommodation space 11h by the supply chamber body 11. The coolant accommodation space 11hi may surround the pellet accommodation space 11h. More specifically, the coolant accommodation space 11hi may surround an outside of the pellet accommodation space 11h. The coolant accommodation space 11hi may surround a portion of the supply unit 3. More specifically, the coolant accommodation space 11hi may surround an outside of an upper portion of the supply unit 3. The supply chamber body 11 may be coupled with the coolant inlet 11i and the coolant outlet 11e. The coolant inlet 11i may be defined in an outer surface of the supply chamber body 11. The coolant outlet 11e may be defined in the outer surface of the supply chamber body 11. The coolant outlet 11e may be disposed higher than the coolant inlet 11i. The coolant accommodation space 11hi may be connected with the coolant inlet 11i. The coolant accommodation space 11hi may be connected with the coolant outlet 11e. A coolant may be disposed in the coolant accommodation space 11hi. The coolant may be supplied to the coolant accommodation space 11hi through the coolant inlet 11i. The coolant may be discharged from the coolant accommodation space 11hi through the coolant outlet 11e. Detailed description thereof will be described later.

The extended body 15 may be coupled to the supply chamber body 11. The extended body 15 may extend upward from the supply chamber body 11. The extended body 15 may have a cylindrical shape. However, the embodiment of the inventive concept is not limited thereto. The extended body 15 may define an extended accommodation space 15h. That is, the extended accommodation space 15h may be defined inside the extended body 15.

The extended accommodation space 15h may not be connected with the pellet accommodation space 11h.

The insertion part 13 may be coupled to the extended body 15 and/or the supply chamber body 11. Hereinafter, it is illustrated for convenience of description that the insertion part 13 is coupled to the extended body 15. In the embodiments, the insertion part 13 may have a predetermined angle with the first direction D1. The insertion part 13 may provide an insertion passage 13h. The insertion passage 13h may be connected to the extended accommodation space 15h and/or the pellet accommodation space 11h. The pellet a may be supplied to the extended accommodation space 15h and/or the pellet accommodation space 11h through the insertion passage 13h. The insertion passage 13h may be connected to the pellet supplier U. The insertion passage 13h may receive the pellet a from the pellet supplier U. The pellet a supplied from the pellet supplier U may be supplied to the extended accommodation space 15h and/or the pellet accommodation space 11h along the insertion passage 13h.

The coolant inlet 11i may be coupled to the outer surface of the supply chamber body 11. The coolant inlet 11i may be connected with an inlet pipe Pi or the like. The coolant inlet 11i may receive the coolant from the inlet pipe Pi. The coolant inlet 11i may transfer the coolant received from the inlet pipe Pi to the pellet accommodation space 11h.

The coolant outlet 11e may be coupled to the outer surface of the supply chamber body 11. The coolant outlet 11e may be connected with an outlet pipe Pi or the like. The coolant outlet 11e may discharge the coolant to the outlet pipe Pi or the like. The coolant outlet 11e may be disposed higher than the coolant inlet 11i. More specifically, the coolant inlet 11i may be disposed at the first direction D1 more than the coolant outlet 11e.

The supply unit 3 may be connected to the supply chamber 1. The supply unit 3 may include a supply pipe 31 and a nozzle 33.

The supply pipe 31 may be connected to the supply chamber body 11. More specifically, the supply pipe 31 may be connected to a central portion of the supply chamber body 11. The supply pipe 31 may extend in the first direction D1. The supply pipe 31 may extend from the supply chamber body 11 in the first direction D1. The supply pipe 31 may provide the inner space 31h. The inner space 31h may extend along the supply pipe 31 in the first direction D1. The inner space 31h may be connected with the pellet accommodation space 11h. The pellet a (refer to FIG. 4) may move from the pellet accommodation space 11h to the inner space 31h.

The nozzle 33 may be coupled to the supply pipe 31. More specifically, the nozzle 33 may be coupled to a lower end of the supply pipe 31. The nozzle 33 may have a diameter that gradually decreases in the first direction D1. The nozzle 33 may include a connection space 33h and a discharge hole 33e. The connection space 33h may be connected to the inner space 31h of the supply pipe 31. The connection space 33h may have a diameter that gradually decreases in the first direction D1. The discharge hole 33e may be connected to the connection space 33h. The discharge hole 33e may be connected to the outside. The connection space 33h may be connected to the outside through the discharge hole 33e.

The rotation unit 5 may include a rotation shaft 51, a screw 53, a connection shaft 55, and a scraper 57.

The rotation shaft 51 may extend in the first direction D1. The rotation shaft 51 may be disposed in the supply pipe 31. The rotation shaft 51 may be connected to the connection shaft 55. The rotation shaft 51 may rotate by the connection shaft 55. More specifically, the rotation shaft 51 may receive torque from the driving unit m through the connection shaft 55 to rotate in clockwise and counterclockwise directions. Detailed description thereof will be described later with reference to FIGS. 4 to 8.

The screw 53 may be coupled to the rotation shaft 51. More specifically, the screw 53 may be coupled to an outer surface of the rotation shaft 51. The screw 53 may be coupled to the outer surface of the rotation shaft 51 to progress in the first direction D1. Detailed description of the screw 53 will be described later.

The connection shaft 55 may be coupled to an upper side of the rotation shaft 51. The connection shaft 55 may extend in the first direction D1. At least a portion of the connection shaft 55 may be disposed in the supply chamber 1. The connection shaft 55 may be connected to the driving unit m. The connection shaft 55 may transmit a rotation force of the driving unit m to the rotation shaft 51.

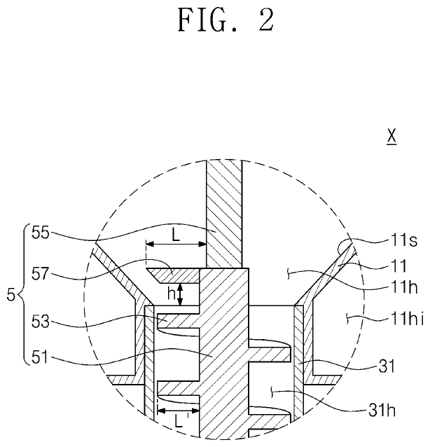

The scraper 57 may be connected to the rotation shaft 51 or the connection shaft 55. When the scraper 57 is coupled to the rotation shaft 51, the scraper 57 may be coupled to the upper side of the rotation shaft 51. The scraper 57 may be disposed higher than the screw 53. The scraper 57 may have a bar shape. The scraper 57 may have an extension direction crossing the first direction D1. For example, the extension direction of the scraper 57 may be substantially perpendicular to the first direction D1. More specifically, the extension direction of the scraper 57 may be disposed on a plane defined by the second direction D2 and the third direction D3. Detailed description of the scraper 57 will be described later with reference to FIG. 2.

The heating unit 7 may heat the supply part 3. The heating unit 7 may be coupled to the supply part 3. For example, the heating unit 7 may be coupled to the lower end of the supply pipe 31. The heating unit 7 may heat the pellet a in the inner space 31h of the supply pipe 31. The heating unit 7 may include a hot wire 73 and a support member 71. The hot wire 73 may receive electrical energy from an external power (not shown). When the hot wire 73 receives the electrical energy, joule heat may be generated. The hot wire 73 may transfer heat to the inner space 31h of the supply pipe 31. A portion or all of the pellet a may be melted when receives the heat. The support member 71 may fix the hot wire 73.

The driving unit m may be connected to the connection shaft 55. The driving unit m may provide torque to the connection shaft 55. The driving unit m may include various units providing a rotation force. For example, the driving unit m may include a motor. However, the embodiment of the inventive concept is not limited thereto.

The pellet supplier U may be connected to the insertion part 13. The pellet supplier U may supply the pellet a. The pellet supplier U may supply the pellet a to the insertion part 13.

The coolant pump P may supply a coolant to the coolant accommodation space 11hi. The coolant pump P may be connected to the coolant inlet 11i and/or the coolant outlet 11e. More specifically, the coolant pump P may be connected to the coolant inlet 11i through the inlet pipe Pi or connected to the coolant outlet 11e through the outlet pipe Pe.

FIG. 2 is an enlarged cross-sectional view illustrating portion X of FIG. 1.

Referring to FIG. 2, the scraper 57 may be disposed above the screw 53. The scraper 57 may be disposed higher than the supply unit 3. That is, the scraper 57 may be disposed in the supply chamber 1. More specifically, the scraper 57 may be disposed inside the supply chamber body 11. In other words, the scraper 57 may be disposed in the pellet accommodation space 11h. The scraper 57 may be spaced apart from the supply unit 3 in a direction opposite to the first direction D1. That is, the scraper 57 may be spaced upward from an upper boundary of the supply unit 3. That is, the scraper 57 may be spaced by h from the upper boundary of the supply unit 31. In the embodiments, the h is about 0.5 mm or more and about 2 mm or less.

The scraper 57 may have a length L in the extension direction thereof, and the length L may be greater than L′ in the extension direction of the scraper 57. That is, the scraper 57 may extend outward from the rotation shaft 51 more than the screw 53. For example, the scraper 57 may extend outward from the rotation shaft 51, and a portion of an outer side of the scraper 57 may be disposed above the supply pipe 31.

The coolant accommodation space 11hi may surround a portion of an upper portion of the supply pipe 31 and/or a portion or all of the pellet accommodation space 11h. The coolant disposed in the coolant accommodation space 11hi may absorb heat from each of a portion of the upper portion of the supply pipe 31 and/or a portion or all of the pellet accommodation space 11h. Detailed description regarding this will be described later.

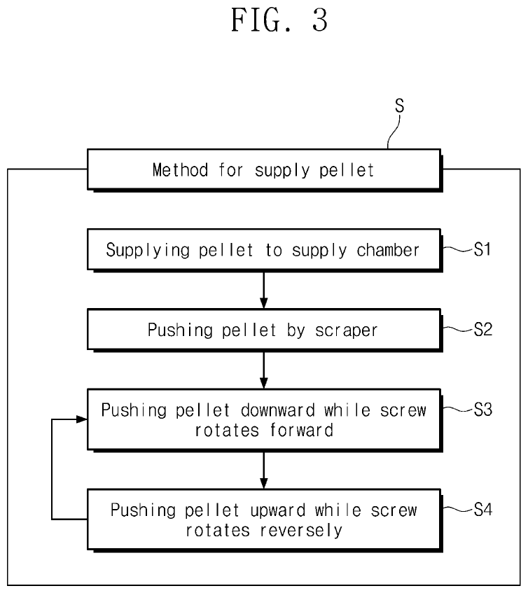

FIG. 3 is a flowchart representing a method for supplying a pellet according to an embodiment of the inventive concept.

Referring to FIG. 3, a method S for supplying a pellet may include a process S1 of supplying a pellet to a supply chamber, a process S2 of pushing the pellet by a scraper, a process S3 of pushing the pellet downward while a screw rotates forward, and a process S4 of pushing the pellet upward while the screw rotates reversely.

Hereinafter, each of the processes of the method S for supplying the pellet will be described in detail with reference to FIGS. 4 to 8.

FIGS. 4 to 8 are cross-sectional views sequentially illustrating the method for supplying the pellet in FIG. 3.

Referring to FIGS. 3 and 4, the process S1 of supplying a pellet to the supply chamber may include a process of supplying a pellet a from the pellet supplier U to the insertion part 13. The pellet a may include a 3-D printing material. For example, the pellet a may include a polymer material. More specifically, the pellet a may include a thermoplastic polymer. The pellet a may further include another material for strength increase and/or thermal stability. For example, the pellet a may further include various inorganic materials. In addition, the pellet a may include various materials for the 3-D printing. The pellet a may have a granule shape. The pellet a inserted to the insertion passage 13h of the insertion part 13 may move downward by the gravity. That is, the pellet a may move from the insertion passage 13h to the pellet accommodation space 11h. The pellet for the 3-D printing may be stacked in the pellet accommodation space 11h.

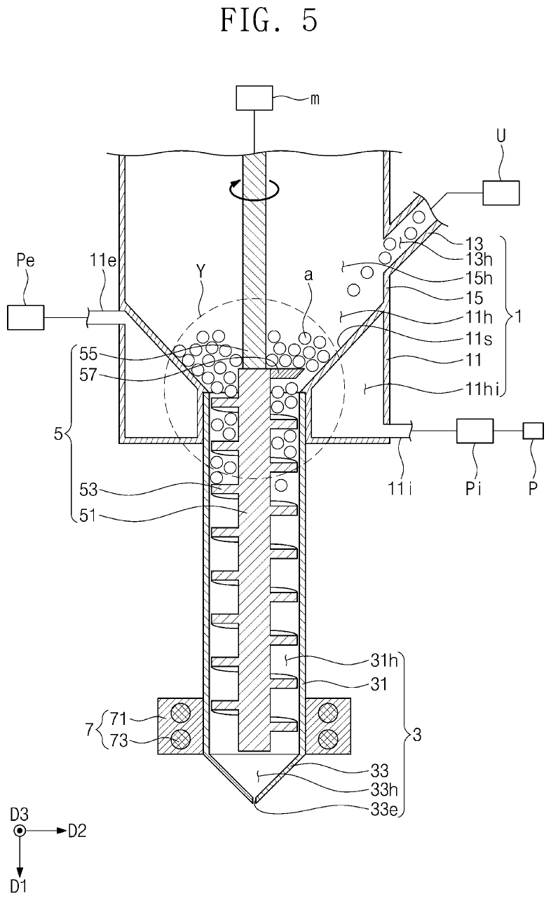

Referring to FIGS. 3 and 5, the process S2 of pushing the pellet by the scraper may include a process in which the rotation part 5 rotates by the driving unit m. More specifically, the connection shaft 55 may rotate by being driven by the driving unit m. Along a progress direction of the screw 53, a forward rotation direction of the connection shaft 55 may be determined. For example, when the screw 53 progresses clockwise, clockwise rotation may be the forward rotation of the connection shaft 55. On the contrary, when the screw 53 progresses counterclockwise, counterclockwise rotation may be the forward rotation of the connection shaft 55. When the connection shaft 55 rotates forward, the rotation shaft 51 also may rotate forward. Each of the scraper 57 and the screw 53 may rotate forward by the forward rotation of the rotation shaft 51. The scraper 57 may push the pellet a in the pellet accommodation space 11h while rotating. More specifically, the scraper 57 may push the pellet a upward and/or downward while rotating. As the scraper 57 pushes the pellet a, a feature in which the pellet a does not move downward because the pellets a collide each other may be prevented. Thus, a bottleneck phenomenon of the pellet a at an inlet of the supply unit 3 may be prevented.

In the pellet supply apparatus and the method for supplying the pellet according to the embodiments of the inventive concept, the pellet may be transferred from the supply chamber to the supply pipe by using the scraper. That is, the scraper stirs the pellets gathered in a lower end of the supply chamber to prevent the pellet from being clogged by the bottleneck phenomenon. Thus, the pellet may be smoothly supplied to the supply pipe. Thus, the pellet may be uniformly extruded. Also, uniformity of the 3-D printing may improve.

In the pellet supply apparatus and the method for supplying the pellet according to the embodiments of the inventive concept, a material having a pellet shape instead of a filament shape may be uniformly extruded. Thus, a material is unnecessarily manufactured into the filament shape. Thus, a process may be simplified, and a manufacturing cost may be saved. Also, various materials in which a content of an inorganic material is high may be used. Thus, strength and thermal stability of a material may improve.

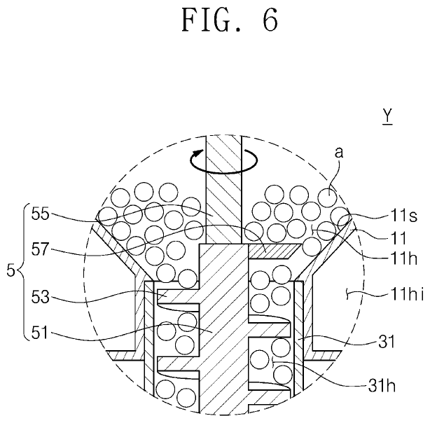

Referring to FIG. 6, the pellet a may be pushed by the scraper 57 to move in the first direction D1. As the bottleneck phenomenon caused by collision between the pellets s is prevented, the pellet a may be uniformly supplied to the supply pipe 31.

Referring to FIGS. 2, 5, and 6, the process S3 of pushing the pellet downward while the screw rotates forward may include a process of pushing the pellet a downward, which is supplied to the supply pipe 31 by the scraper 57, by the screw 53. The screw 53 may push the pellet a along the supply pipe 31 in the first direction D1 while rotating. Thus, the pellet a may be continuously pushed downward.

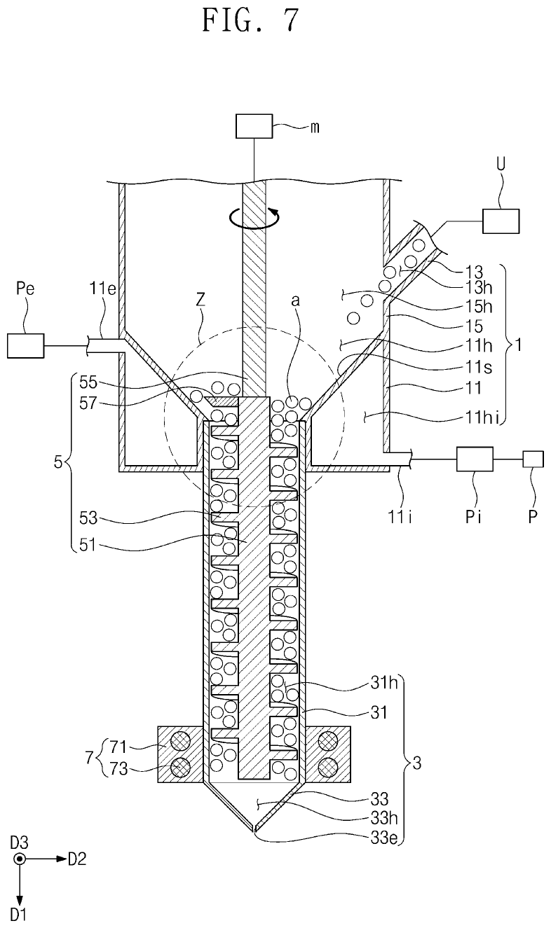

Referring to FIGS. 2 and 7, the process S4 of pushing the pellet upward while the screw rotates reversely may include a process in which the screw 53 rotates forward a predetermined number repeatedly, and then reversely rotates. In the embodiments, a ration between the forward rotation and the reverse rotation may be about 5:1 to about 15:1. The ration between the forward rotation and the reverse rotation of the screw 53 may be determined in various methods. In the embodiments, the ratio between the forward rotation and the reverse rotation of the screw 53 may be determined according to the diameter of the nozzle 33 and/or a printing speed of a 3-D printer. For example, when the nozzle 33 has a diameter of about 400 μm to about 600 μm, and the printing speed is about 30 mm/sec, the ratio between the forward rotation and the reverse rotation of the screw 53 may be about 10:1. That is, the screw 53 rotates forward about 5 turns and then rotates reversely about 0.5 turn. When the diameter of the nozzle 33 increases, the ratio of the forward rotation may increase. On the contrary, when the diameter of the nozzle 33 decreases, the ratio of the forward rotation may decrease. Also, the ratio of the forward rotation may be changed according to the constituents and/or kind of the pellet a.

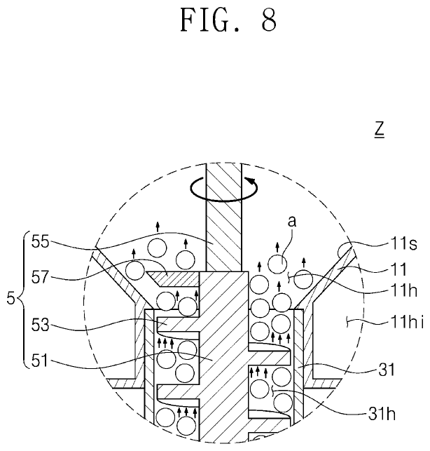

Referring to FIG. 8, when the screw 53 reversely rotates, the pellet a moves upward. That is, the pellet a moving downward in the first direction D1 may move back in an upward direction. A portion of the pellet a, which is disposed at an upper side of the supply pipe 31 may move out of the supply pipe 31. The pellet a may return to the supply chamber 1. That is, the pellet a may return to the pellet accommodation space 11h.

Referring to FIG. 2 again, when the reverse rotation of the screw 53 is finished, the screw 53 may rotate forward again. The forward rotation and the reverse rotation of the screw 53 may be repeated according to a predetermined ratio.

In the pellet supply apparatus and the method for supplying the pellet according to the embodiments of the inventive concept, the forward rotation and the reverse rotation of the screw may be repeated. Thus, pores or the like disposed between the pellet in the supply pipe may be discharged to the supply chamber. Thus, the pellet may be uniformly extruded through the nozzle.

In the embodiments, the method S for supplying the pellet may further include a process of supplying the coolant to the coolant accommodation space in the supply chamber. That is, the coolant pump P may supply the coolant to the coolant accommodation space 11hi. The coolant may be supplied to the coolant accommodation space 11hi through the coolant inlet 11i. The coolant may include various materials capable of absorbing heat. In the embodiments, the coolant may include a secondary coolant having no phase change. For example, the coolant may include water. However, the embodiment of the inventive concept is not limited thereto. For example, the coolant may include various materials. The coolant may be disposed in the coolant accommodation space 11hi to absorb heat from a portion of the supply pipe 31 and/or the pellet accommodation space 11h. The coolant may be supplied at various times. For example, the coolant may be supplied to the coolant accommodation space 11hi in advance before the pellet a is inserted to the pellet accommodation space 11h. Alternatively, the coolant may move downward along the supply pipe 31 and be supplied to the coolant accommodation space 11hi after heated by the heating unit 7.

In the pellet supply apparatus and the method for supplying the pellet according to the embodiments of the inventive concept, a portion of the supply pipe and/or the pellet accommodation space may be cooled by using the coolant. That is, the coolant may absorb the heat from pellet disposed in a portion of the supply pipe and/or in the pellet accommodation space. Thus, the pellet disposed in a portion of the supply pipe and/or in the pellet accommodation space may be prevented from being melted early by heat conducted from the heating unit. Thus, a phenomenon in which the pellet is melted early and attached to a wall surface of the supply pipe and/or a surface of the screw may be prevented. Due to this, the pellet may be uniformly extruded.

In the pellet supply apparatus and the method for supplying the pellet according to the embodiments of the inventive concept, the coolant outlet may be disposed higher than the coolant inlet. Thus, the coolant having a lower temperature may absorb heat from the pellet disposed more adjacent to the heating unit. Thus, the pellet may be effectively cooled.

In the apparatus for supplying the pellet and the method for supplying the pellet according to the embodiments of the inventive concept, the pellet may be uniformly extruded.

In the apparatus for supplying the pellet and the method for supplying the pellet according to the embodiments of the inventive concept, the bottleneck phenomenon of the pellet at the inlet of the supply unit may be prevented.

In the apparatus for supplying the pellet and the method for supplying the pellet according to the embodiments of the inventive concept, the pore in the supply unit may be removed.

In the apparatus for supplying the pellet and the method for supplying the pellet according to the embodiments of the inventive concept, the early melting of the pellet may be prevented.

In the apparatus for supplying the pellet and the method for supplying the pellet according to the embodiments of the inventive concept, the clogging of the pellet due to the melting of the pellet may be prevented.

In the apparatus for supplying the pellet and the method for supplying the pellet according to the embodiments of the inventive concept, various materials may be used in the 3-D printing.

In the apparatus for supplying the pellet and the method for supplying the pellet according to the embodiments of the inventive concept, the process may be simplified.

The object of the present invention is not limited to the aforesaid, but other objects not described herein will be clearly understood by those skilled in the art from descriptions below.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Thus, the above-disclosed embodiments are to be considered illustrative and not restrictive.

What is claimed is:

1. An apparatus for supplying a pellet, the apparatus comprising:
a supply chamber configured to accommodate a pellet;
a rotation unit connected to a driving unit; and
a supply unit coupled to the supply chamber,
wherein the rotation unit comprises:
a rotation shaft extending in a first direction;
a screw coupled to an outer surface of the rotation shaft and configured to progress in the first direction; and
a scraper extending from the outer surface of the rotation shaft in a direction crossing the first direction,
wherein the supply unit surrounds the screw, and
the scraper is disposed in the supply chamber while being positioned higher than the screw.

2. The apparatus of claim 1, wherein the scraper has an extension direction perpendicular to the first direction.

3. The apparatus of claim 1, wherein the scraper has a bar shape.

4. The apparatus of claim 1, wherein the scraper is spaced upward by about 0.5 mm to about 2 mm from an upper boundary of the supply unit.

5. The apparatus of claim 1, wherein the scraper has a length in the extension direction, which is greater than a length of the screw in the extension direction of the scraper.

6. The apparatus of claim 1, wherein the supply chamber provides a pellet accommodation space having a diameter that gradually decreases in the first direction,
wherein the pellet accommodation space is connected with an inner space of the supply unit, and
a supply chamber body configured to define the pellet accommodation space provides a coolant accommodation space therein.

7. The apparatus of claim 1, further comprising a heating unit coupled to an outer surface of the supply unit,
wherein the heating unit heats the pellet supplied to the inner space of the supply unit.

8. An apparatus for supplying a pellet, the apparatus comprising:
a supply chamber configured to accommodate a pellet;
a rotation unit connected to a driving unit; and
a supply unit coupled to the supply chamber,
wherein the rotation unit comprises:
a rotation shaft extending in a first direction; and
a screw coupled to an outer surface of the rotation shaft and configured to progress in the first direction,
wherein the supply unit surrounds the screw,
the supply chamber comprises a supply chamber body and a pellet accommodation space defined by the supply chamber body,
the pellet accommodation space has a diameter that gradually decreases in the first direction and is connected with an inner space of the supply unit, and
the supply chamber body provides a coolant accommodation space therein.

9. The apparatus of claim 8, wherein the coolant accommodation space surrounds a portion of the supply unit and the pellet accommodation space.

10. The apparatus of claim 8, further comprising a coolant inlet and a coolant outlet, which are coupled to an outer surface of the supply chamber,
wherein each of the coolant inlet and the coolant outlet is connected to the coolant accommodation space.

11. The apparatus of claim 10, wherein the coolant outlet is positioned higher than the coolant inlet.

12. The apparatus of claim 11, further comprising a coolant pump connected to the coolant outlet or the coolant inlet.

13. A method for supplying a pellet, the method comprising:
supplying a pellet to a supply chamber;
pushing the pellet from the supply chamber to a supply unit by a scraper; and
pushing the pellet downward while a screw disposed in the supply unit rotates forward,
wherein the scraper is disposed in the supply chamber while being coupled to an upper side of a rotation shaft coupled with the screw.

14. The method of claim 13, further comprising pushing the pellet upward while the screw rotates reversely after the screw rotates forward to push the pellet downward.

15. The method of claim 14, wherein a ratio of the forward rotation and the reverse rotation is about 5:1 to about 15:1.

16. The method of claim 13, further comprising supplying a coolant to a coolant accommodation space in the supply chamber.
